(19) United States
(12) Patent Application Publication
(10) Pub. No.: US 2011/0084918 A1
(43) Pub. Date: Apr. 14, 2011

(54) Touch Detection Method and Touch Detection Device and Touch Display Device

(76) Inventor: Kuang-Feng Sung, Taichung County (TW)

(21) Appl. No.: 12/695,168

(22) Filed: Jan. 28, 2010

(30) Foreign Application Priority Data
Oct. 12, 2009 (TW) 098134491

(51) Int. Cl. G06F 3/041

(52) U.S. Cl. 345/173; 345/104

(57) ABSTRACT

A touch detection method, for detecting touch events in a touch pad having a plurality of sense sequences arranged as a matrix, includes outputting a plurality of pulse signals to the plurality of sense sequences, detecting voltage differences between adjacent sense sequences of the plurality of sense sequences when receiving the plurality of pulse signals, to generate a plurality of detection results, and determining a status of an touch event according to the plurality of detection results.

### BACKGROUND OF THE INVENTION

1. Field of the Invention

The present invention relates to a touch detection method, touch detection device, and touch display device, and more particularly, to a touch detection method, touch detection device, and touch display device capable of saving production cost and enhancing utilization convenience.

2. Description of the Prior Art

A touch display device has merits of convenient operation, rapid response, and saving space, such that the touch display device has become an important input interface, and been widely used in various consumer electronic products, such as personal digital assistant, personal computer, smart mobile phone, notebook, and point of sale system (POS). Specifically, the touch display device is composed of a (LCD or CCFL) display device and a transparent touch pad, and in detail, is made by fixing the transparent touch pad onto the display device, to fulfill both touch and display functions. The operation principle of the touch pad is well known for those skilled in the art, where the capacitive touch technique has stable performance, excellent sensitivity and durability, and is the most popular touch technique.

The capacitive touch technique detects capacitance variations caused by static electricity when human body (or an object) touches the touch pad, and determines a touch event accordingly. In other words, the capacitive touch technique detects capacitive characteristics before and after the human body touches a certain point on the touch pad to achieve touch functions. Please refer to FIG. 1. FIG. 1 is a schematic diagram of a capacitive touch pad 10 in the prior art. The capacitive touch pad 10 is composed of sense capacitor sequences X₁-Xₘ and Y₁-Yₙ disposed on a substrate 102. Each sense capacitor sequence is a one-dimensional structure formed by a sequence of sense capacitors. The prior art touch detection method detects capacitance of each sense capacitor sequence to determine whether a touch event occurs. Assume that the sense capacitor sequence X₃ includes “a” pieces of sense capacitors, and the capacitance of each sense capacitor is C. Under normal conditions, the capacitance of the sense capacitor sequence X₃ is aC. If capacitance variation caused by human body (e.g. a finger) touching a sense capacitor of the sense capacitor sequence X₃ is ΔC, then a touch event on the sense capacitor sequence X₃ can be detected when the capacitance of the sense capacitor sequence X₃ is aC+ΔC. Accordingly, as shown in FIG. 1, while a finger touches an intersection of the sense capacitor sequences X₃ and Y₃, the capacitances of the sense capacitor sequences X₃ and Y₃ vary at the same time, and a control module is able to determine that the touch sensing point is at (X₃, Y₃).

Note that, the capacitive touch pad 10 illustrated in FIG. 1 performs merely the touch function, and does not include the display function. To realize a touch display device, the capacitive touch pad 10 must be manufactured by a transparent material, and fixed on a display device. For example, please refer to FIG. 2A and FIG. 2B. FIG. 2A is a schematic diagram of a touch display device 20 according to the prior art, while FIG. 2B is a cross-section diagram of the touch display device 20 along point A to point A′. The touch display device 20 is composed of a liquid crystal display (LCD) panel 200 and a transparent touch pad 202. The LCD panel 200 and the transparent touch pad 202 are agglutinated together by glue or other material. The structure and operating principle of the transparent touch pad 202 are identical to those of the capacitive touch pad 10 shown in FIG. 1, to detect capacitance variations caused by contact of external objects, and determine touch events via a control module (not shown in FIG. 2A and FIG. 2B) accordingly.

As can be seen from the above, the touch display device 20 is a device combining the liquid crystal display panel 200 with the transparent touch pad 202, to fulfill both touch and display functions. Such combination does not help to the integration of the hardware structures of the liquid crystal display panel 200 and the transparent touch pad 202, and may further cause an increment to the whole thickness; thus, it is necessary to improve the prior art touch display device 20.

In addition, the prior art determines touch points by calculating a discharging duration of a sense capacitor sequence, and determining whether a touch event occurs on the sense capacitor sequence. For example, please refer to FIG. 3. FIG. 3 is a functional block diagram of a control module 30 applicable to a touch pad 300 according to the prior art. The touch pad 300 can be the capacitive touch pad 10 of FIG. 1 or the transparent touch pad 202 of FIG. 2A. The control module 30 includes a touch sensing unit 302, a micro control unit 304, a ring counter 306, and a host 308. Capacitance variation of a sense capacitor sequence, resulted from a touch event on the touch pad 300, directly influences a time constant, i.e. charging and discharging time. Thus, while detecting whether capacitance of a sense capacitor sequence changes, the touch sensing unit 302 emits a high-level (logic 1) signal to the sense capacitor sequence, and keeps detecting variation of the high-level signal. According to the detection result provided by the touch sensing unit 302 as well as a stable clock signal generated by the ring counter 306, the micro control unit 304 counts the duration that the level of the high-level signal decreases to a predetermined low level. If the duration exceeds a predetermined value, representing that the capacitance of the sense capacitor sequence has increased, a touch event occurs. Otherwise, no touch event is happened. Repeating such detection procedure, the control module 300 can determine whether a touch event occurs, or where and when a touch event occurs if any.

Therefore, as to the touch event detection method of the touch pad 300, the touch sensing unit 302 must perform detection for each sense capacitor sequence. Under such circumstances, as a size of the touch pad 300 increases, for example, for a large touch display device, the influence and the variation range of the environmental capacitance also increase, resulting in difficulties in practice. Meanwhile, the size increase of the touch pad 300 accompanies time increase for completing the detection cycles, which may cause the incapability of timely reflecting the variation of the touch event, and affect the utilization convenience. Therefore, it is necessary to improve the prior art touch detection method.

### SUMMARY OF THE INVENTION

It is therefore a primary objective of the claimed invention to provide a touch detection method, touch detection device, and touch display device.

The present invention discloses a touch detection device, for detecting touch events in a touch pad having a plurality of sense sequences arranged as a matrix, including a signal output module, for outputting a plurality of pulse signals to the plurality of sense sequences, a voltage-difference detection module, for detecting voltage differences between adjacent sense sequences of the plurality of sense sequences when receiving the plurality of pulse signals, to generate a plurality of detection results, and a determination module, for determining a status of an touch event according to the plurality of detection results.

The present invention further discloses a touch detection device, for detecting touch events in a touch pad having a plurality of sense sequences arranged as a matrix, including a signal output module, for outputting a plurality of pulse signals to the plurality of sense sequences, a voltage-difference detection module, for detecting the voltage differences between adjacent sense sequences of the plurality of sense sequences when receiving the plurality of pulse signals, to generate a plurality of detection results, and a determination module, for determining a status of an touch event according to the plurality of detection results.

The present invention further discloses a touch display device having display and touch functions, including a liquid crystal display panel, comprising a plurality of pixel units and a plurality of wires arranged as a matrix, each pixel unit formed at an intersection of two orthogonal wires, an image driving module, for outputting a plurality of control signals and a plurality of image data signals to the plurality of wires according to an image data, to drive the plurality of pixel units to display images, and a touch detection device, coupled to the plurality of wires, for determining a status of an touch event according to capacitance variation of the plurality of wires.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a capacitive touch pad according to the prior art.

FIG. 2A is a schematic diagram of a touch display device according to the prior art.

FIG. 2B is a cross-section diagram of the touch display device in FIG. 2A.

FIG. 3 is a functional block diagram of a control module applicable to a touch pad according to the prior art.

FIG. 4A is a schematic diagram of a touch display device according to the present invention.

FIG. 4B is a cross-section diagram of the touch display device in FIG. 4A

FIG. 4C is a functional block diagram of the touch display device in FIG. 4A.

FIG. 5 is a schematic diagram of the relevant signals in FIG. 4A.

FIG. 6A and FIG. 6B are schematic diagrams of a voltage-difference detection module in FIG. 4C.

FIG. 7 is a schematic diagram of a touch detection process according to the present invention.

### DETAILED DESCRIPTION

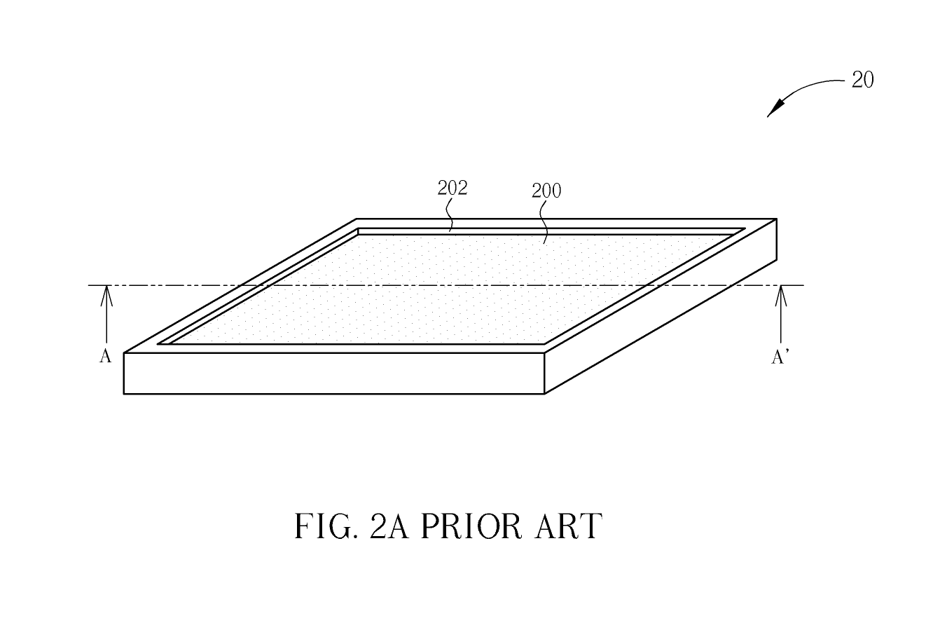

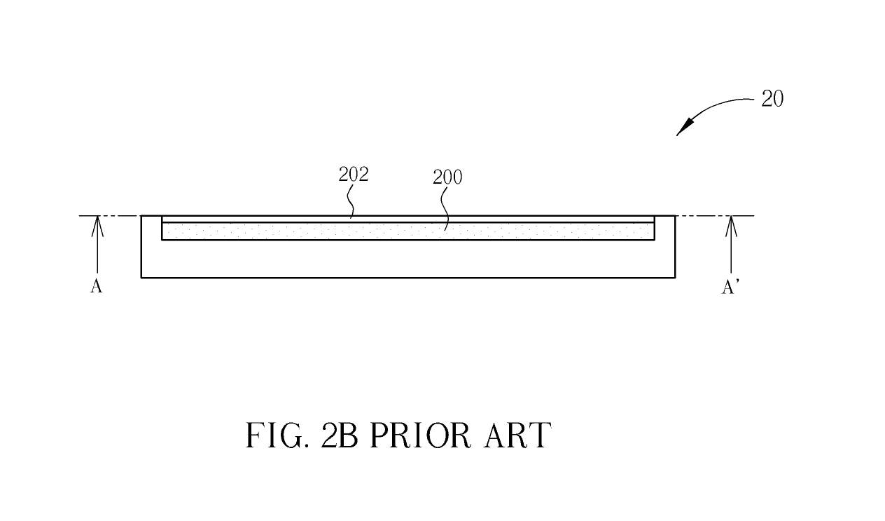

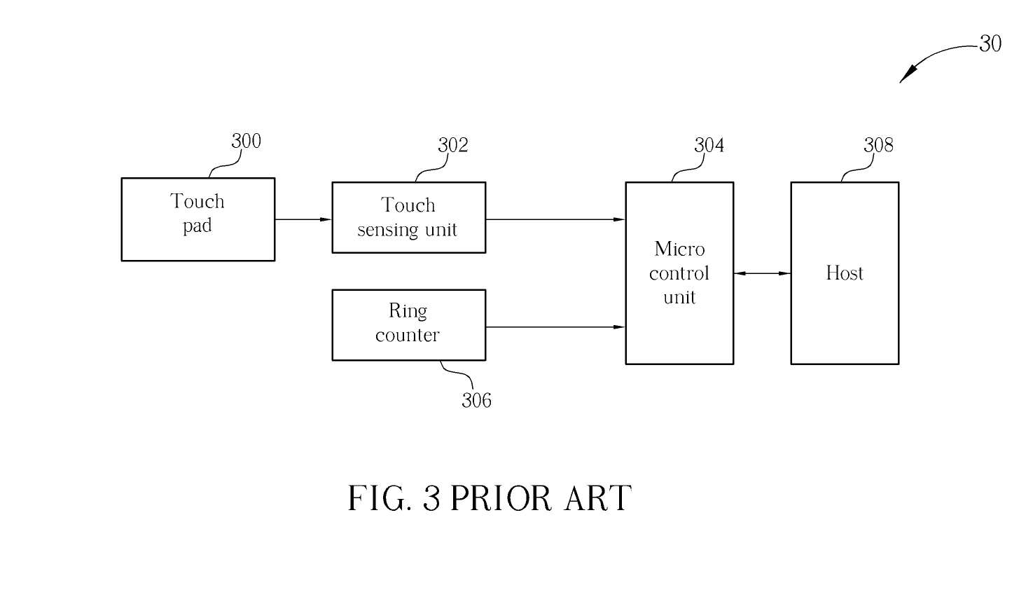

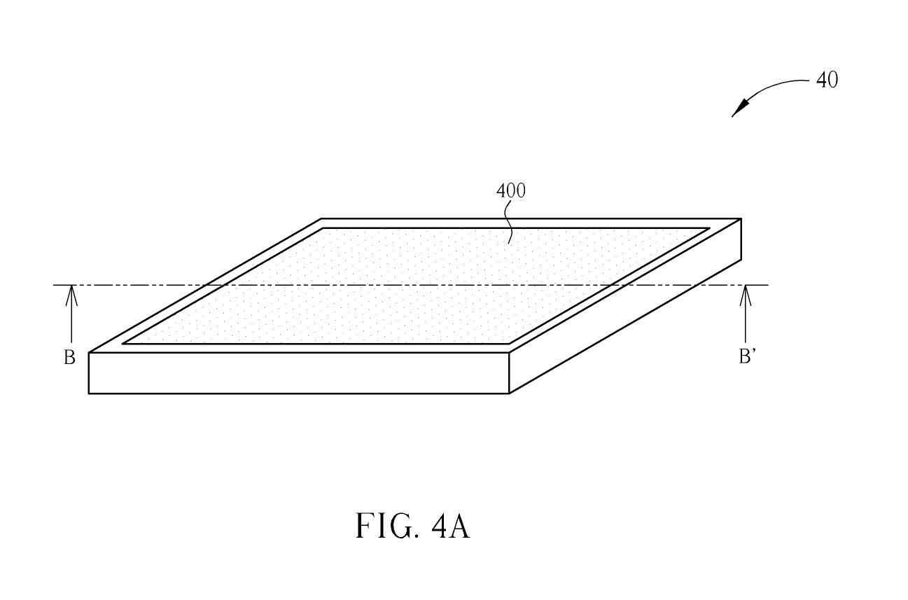

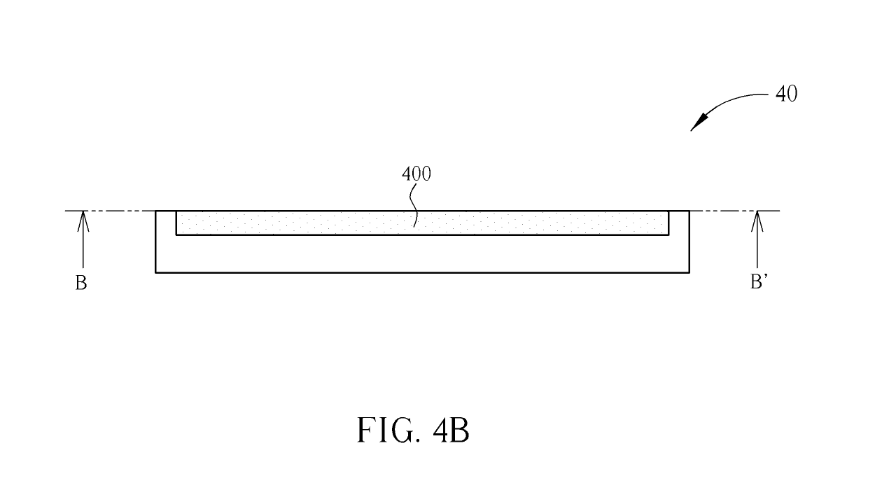

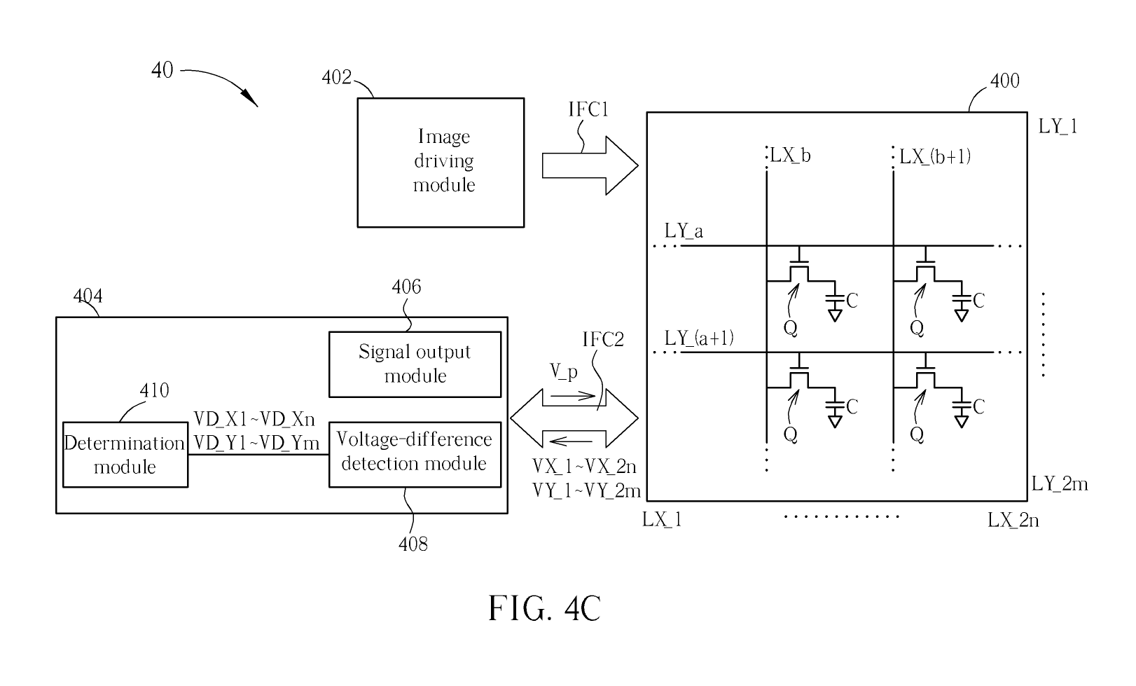

Please refer to FIG. 4A to FIG. 4C. FIG. 4A is a schematic diagram of a touch display device 40 according to an embodiment of the present invention, FIG. 4B is a cross-section diagram of the touch display device 40 along point B to point B′, and FIG. 4C is a functional block diagram of the touch display device 40. As can be seen from FIG. 4A and FIG. 4B, the touch display device 40 fulfills the touch and display functions via a liquid crystal display panel 400. In other words, no extra transparent touch pad 202 illustrated in FIG. 2 needs to be installed in the touch display device 40 while the goal of detecting touch events can be reached.

In detail, as illustrated in FIG. 4C, in addition to the liquid crystal display panel 400, the touch display device 40 further includes an image driving module 402 and a touch detection device 404. The liquid crystal display panel 400 is formed by two substrates stuffed with liquid crystal. One of the two substrates is disposed wires LX_1-LX_2n, wires LY_1-LY_2m, and a plurality of thin-film transistors (TFTs) Q. The other substrate is disposed a common electrode. The structure of the liquid crystal display panel 400 is well known for those skilled in the art, and is not a dominant issue of the present invention. Thus, FIG. 4C denotes the liquid crystal display panel 400 with only the wires LX_b, LX_(b+1), LY_a, LY_(a+1) and four TFTs Q for simplicity. Meanwhile, denominations of the wires LX_1-LX_2n and LY_1-LY_2m are used to specify the concept of the present invention, and in practice, the wires LX_1-LX_2n can also be named as scan lines or gate lines, while the wires LY_1-LY_2m can be named as data lines or source lines. Moreover, the characteristic of the two substrates of the liquid crystal display panel 400 can be represented by an equivalent capacitor C. According to image data to be shown, the image driving module 402 outputs control signals and data signals to the wires LX_1-LX_2n and LY_1-LY_2m to control conductivities of each TFT Q and voltage differences of the equivalent capacitor C, and further changes the arrangement of liquid crystal molecules and corresponding light transmittance, to control gray levels of corresponding pixels; hence, image is displayed on the panel.

Note that, the image driving module 402 represents a combination of elements, circuits, firmware, etc. utilized for controlling the liquid crystal display panel 400 to display images in the touch display device 40. In practice, the image driving module 402 may comprise a timing controller, gate driver, source driver, and common voltage generator, while for clarity, these are simplified to a functional block of the image driving module 402 on the premise that the concept of the present invention is not affected. Likewise, an interface IFC1 between the image driving module 402 and the liquid crystal display panel 400 denotes all tangible or intangible connections, may vary according to application scope or system requirement, and is not limited to the above.

The present invention can reach touch and display functions without an extra transparent touch pad. As shown in FIG. 4C, the touch detection device 404 includes a signal output module 406, a voltage-difference detection module 408 and a determination module 410. The signal output module 406 outputs a pulse signal V_p to the wires LX_1-LX_2n and LY_1-LY_2m via an interface IFC2. The voltage-difference detection module 408 is utilized for detecting the voltages VX_1-VX_2n and VY_1-VY_2m when the wires LX_1-LX_2n and LY_1-LY_2m receive the pulse signal V_p, and determining the voltage differences between adjacent wires accordingly, so as to generate corresponding voltage difference results VD_X1-VD_Xn and VD_Y1-VD_Ym. Finally, the determination module 410 determines whether a touch event occurs, or where and when a touch event occurs if any.

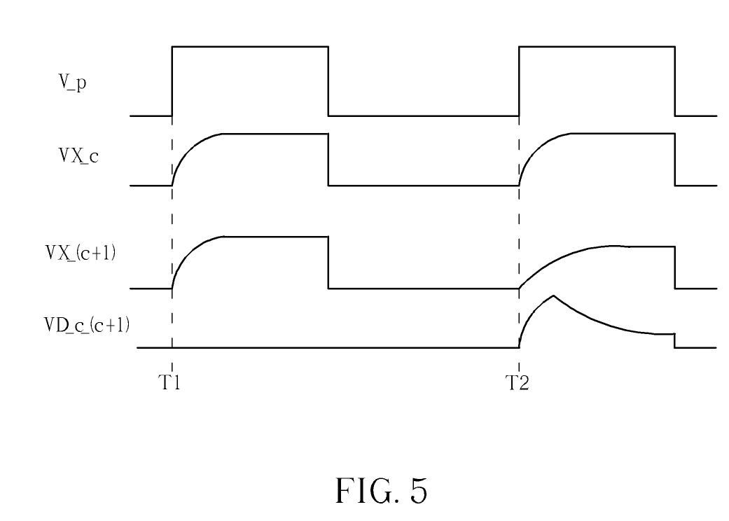

In brief, the touch detection device 404 outputs the pulse signal V_p to the wires LX_1-LX_2n and LY_1-LY_2m originally formed in the liquid crystal display panel 400, and determines whether there is a voltage difference between adjacent wires greater than a predetermined value when receiving the pulse signal V_p due to electric interference, so as to determine whether a touch event occurs, or where and when a touch event occurs. Take a wire LX_c and an adjacent wire LX_(c+1) for example. If a touch event occurs on the wire LX_(c+1), the corresponding signals can be illustrated by FIG. 5. In FIG. 5, at a time point T1, no touch event is occurred, so that the wires LX_c and LX_(c+1) are affected by the same electric interference. Hence, while receiving the pulse signal V_p outputted from the signal output module 406, the corresponding voltages VX_c and VX_(c+1) of the wires LX_c and LX_(c+1) have the same rising range and tendency. Under the circumstances, a voltage difference result VD_c_(c+1) of the voltages VX_c and VX_(c+1) is 0. Next, before a time point T2, a touch event occurs on the wire LX_(c+1), resulting in different electric interference in the wires LX_c and LX_(c+1). Hence, when the signal output module 406 outputs the pulse signal V_p again at the time point T2, the voltages VX_c and VX_(c+1) present different rising ranges and tendencies, and consequently, the voltage difference result VD_c (c+1) of the voltages VX_c and VX_(c+1) is greater than 0. In this way, the determination module 410 can determine that a touch event occurs on the wire LX (c+1) at the time point T2.

Therefore, without an extra transparent touch pad, the touch detection device 404 utilized transmission and reception of the pulse signal V_p, to determine whether a touch event occurs on the liquid crystal display panel 400, or where and when a touch event occurs. Noticeably, for reaching uniform display quality, capacitance difference between any different pixels on the liquid crystal display panel 400 is designed to be quite tiny. Therefore, when a finger clicks on the liquid crystal display panel 400, the present invention detects the voltage difference between adjacent wires, to distinguish whether there is a finger touch causing capacitance variation. Under the circumstances, besides the advantage of unnecessary of transparent touch pad, for large display device, the present invention is capable of rapidly and precisely determining the statuses and contents of touch events. Therefore, the present invention can enhance utilization convenience and reduce production cost of the touch display device, and is beneficial for touch display devices of large size.

Note that, the functional block diagram illustrated in FIG. 4C is used for denoting the operating principles of the touch display device 40, and the corresponding realization can be adequately modified according to different requirements. For example, although in FIG. 4C the interfaces IFC1 and IFC2 are represented by two independent items, the interfaces IFC1 and IFC2 can be the same interface in practice. Besides, the main function of the touch detection device 404 includes outputting the pulse signal V_p, detecting the voltage difference between the adjacent wires, and determining the status of the touch event accordingly, and alternations and modifications derived from the above concept are involved in the present invention. Take the signal output module 406 as an example, time to output the pulse signal V_p (or time to detect the pulse signal V_p by the touch detection device 404) can cooperate with the operations of the image driving module 402, e.g. to perform a full screen detection during a vertical blanking time or perform detection of specific wires during a horizontal blanking time, in order to maintain normal displays of the screen. Certainly, emitting periods, generating ways, signal formats of the pulse signal V_p should be adequately modified according to the system requirements, and are not limited to the above examples. Furthermore, the signal output module 406 can also be realized by a gate driving circuit and a source driving circuit of the image driving module 402, and timely emit the pulse signal V_p with control commands of a timing controller. As a result, no need to perform a large scale of modification, but to adjust operation firmwares of the timing controller, the gate driving circuit and the source driving circuit, the complete functions of the signal output module 406 can be realized, and thus, production cost can be reduced.

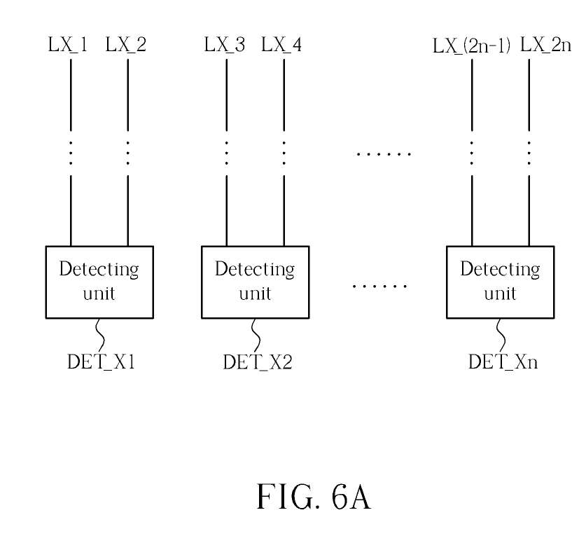

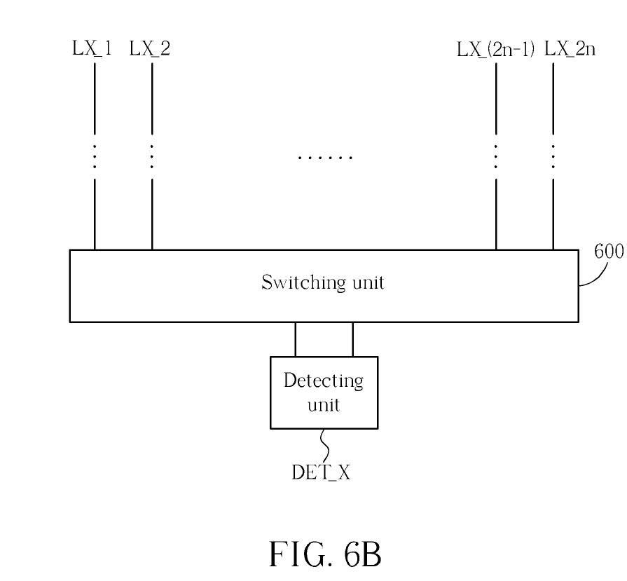

In addition, in FIG. 4C, the signal output module 406, the voltage-difference detection module 408 and the determination module 410 are respectively denoted by single blocks, by which the purpose is to depict the operational principles of the modules, and in practice, each of the modules can be composed of units more than one. For example, in FIG. 6A, the detecting units DET_X1-DET_Xn are utilized for detecting the voltage differences of the adjacent wires among the wires LX_1-LX_2n, and realize a part (half) of the voltage-difference detection module 408. The detecting units DET_X1-DET_Xn can be differential amplifiers or comparators utilized for detecting voltage differences of adjacent wires respectively. Furthermore, in FIG. 6B, a switching unit 600 and a detecting unit DET_X are used to replace the detecting units DET_X1-DET_Xn. The switching unit 600 sequentially switches a wire to be connected with the detecting unit DET_X. Therefore, the circuit space or production cost can be reduced. Certainly, regardless of whether the embodiment in FIG. 6A or the embodiment in FIG. 6B is adopted to realize the voltage-difference detection module 408, the primary objective is to detect the voltage difference of the adjacent wires to meet the requirements of the present invention. Moreover, when the embodiment in FIG. 6A is applied for realizing the voltage-difference detection module 408, the signal output module 406 simultaneously outputs the pulse signal V_p to all wires. When the embodiment in FIG. 6B is applied for realizing the voltage-difference detection module 408, the signal output module 406 should sequentially outputs the pulse signals V_p to the wires according to a switching clock of the switching unit 600. In other words, when designing the touch detection device 404, a designer should adjust the operations according to the practical needs, and should not be limited to the above embodiments.

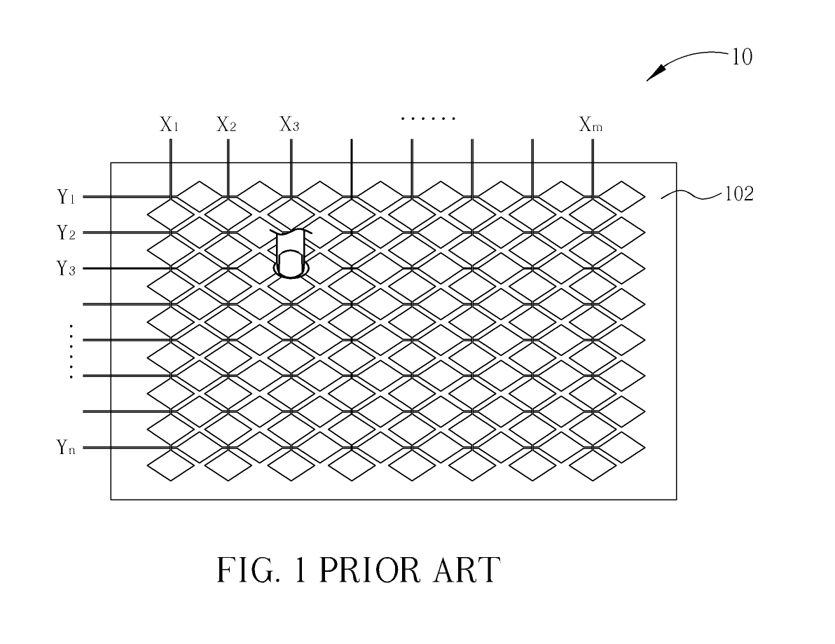

On the other hand, although the above description takes the liquid crystal display panel 400 as an example to interpret that the present invention can realize the touch detection function on the liquid crystal display panel 400. Nevertheless, except for the liquid crystal display panel 400, the traditional touch pad (e.g. the example shown in FIG. 1) can also adopt the concept of the touch detection device 404. That is, output a pulse signal to the sense sequence of the touch pad via a signal output module, then detect the voltage differences between adjacent sense sequences when receiving the pulse signal via a voltage-difference detection module, and last, use a determination module to determine the status of a touch event according to voltage difference results.

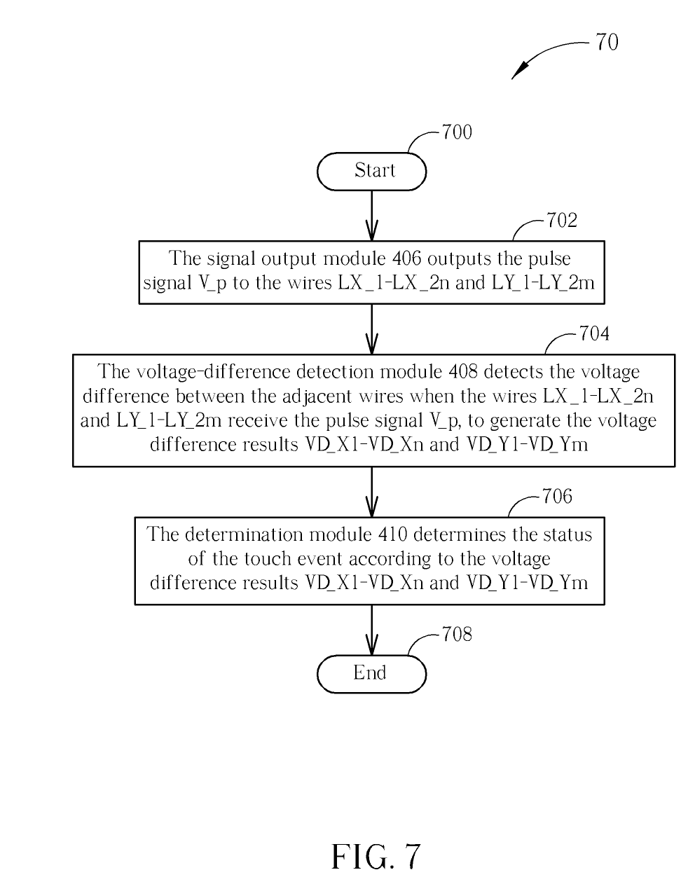

Furthermore, the above operations of the touch detection device 404 can be concluded into a touch detection process 70, as shown in FIG. 7, and is applicable to touch pads or other devices. The touch detection process 70 includes the following steps:

Step 700: Start.

Step 702: The signal output module 406 outputs the pulse signal V_p to the wires LX_1-LX_2n and LY_1-LY_2m.

Step 704: The voltage-difference detection module 408 detects the voltage difference between the adjacent wires when the wires LX_1-LX_2n and LY_1-LY_2m receive the pulse signal V_p, to generate the voltage difference results VD_X1-VD_Xn and VD_Y1-VD_Ym.

Step 706: The determination module 410 determines the status of the touch event according to the voltage difference results VD_X1-VD_Xn and VD_Y1-VD_Ym.

Step 708: End.

The touch detection process 70 is utilized for interpreting the operations of the touch detection device 404, and can be referred to the above narration for detail, which is not narrated herein.

In the prior art, for realizing a touch display device, a transparent touch pad must be added to a display device, resulting in the increase of production cost. In the meanwhile, the prior art touch detection method is unfavorable to the application of large size panels. In comparison, the present invention detects the voltage differences between adjacent wires, to determine whether a voltage difference is greater than a predetermined value due to the corresponding wire affected by electric interference, so as to determine whether a touch event occurs, or where and when a touch event occurs if any. Therefore, while realizing the invention idea on the liquid crystal display panel, the present invention does not need an extra touch pad, and production cost can hence be reduced. More importantly, for large size applications, the present invention can rapidly and precisely determine the statuses and contents of touch events, to enhance the utilization convenience.

Those skilled in the art will readily observe that numerous modifications and alterations of the device and method may be made while retaining the teachings of the invention.

What is claimed is:

1. A touch detection method, for detecting touch events in a touch pad having a plurality of sense sequences arranged as a matrix, comprising:
outputting a plurality of pulse signals to the plurality of sense sequences;
detecting voltage differences between adjacent sense sequences of the plurality of sense sequences when receiving the plurality of pulse signals, to generate a plurality of detection results; and
determining a status of an touch event according to the plurality of detection results.

2. The touch detection method of claim 1, wherein the step of determining the status of the touch event according to the plurality of detection results is determining that the touch event occurs on a first sense sequence or a second sequence adjacent to the first sense sequence when the plurality of detection results indicate that a voltage difference between the first sense sequence and the second sense sequence, when receiving the pulse signals, is greater than a predetermined value.

3. The touch detection method of claim 1, wherein the step of determining the status of the touch event according to the plurality of detection results is determining that the touch event does not occur when the plurality of detection results indicate that a voltage difference between the first sense sequence and the second sense sequence, when receiving the pulse signals, is smaller than a predetermined value.

4. The touch detection method of claim 1, wherein the step of determining the status of the touch event according to the plurality of detection results is determining that an erroneous decision occurs when the plurality of detection results indicate that an amount of voltage differences, between adjacent sense sequences of the plurality of sense sequences and greater than a predetermined value, is greater than a predetermined number.

5. The touch detection method of claim 1, wherein the step of outputting the plurality of pulse signals to the plurality of sense sequences is outputting the plurality of pulse signals to the plurality of sense sequences at the same time.

6. The touch detection method of claim 1, wherein the step of outputting the plurality of pulse signals to the plurality of sense sequences outputs the plurality of pulse signals to the plurality of sense sequences in order.

7. The touch detection method of claim 6, wherein the step of detecting the voltage differences between the adjacent sense sequences of the plurality of sense sequences when receiving the plurality of pulse signals is sequentially detecting the voltage differences between the adjacent sense sequences of the plurality of sense sequences when receiving the plurality of pulse signals, to generate the plurality of detection results.

8. The touch detection method of claim 1, wherein the touch pad is a liquid crystal display panel, and the plurality of sense sequences are scan lines and data lines of the liquid crystal display panel.

9. A touch detection device, for detecting touch events in a touch pad having a plurality of sense sequences arranged as a matrix, comprising:
a signal output module, for outputting a plurality of pulse signals to the plurality of sense sequences;
a voltage-difference detection module, for detecting voltage differences between adjacent sense sequences of the plurality of sense sequences when receiving the plurality of pulse signals, to generate a plurality of detection results; and
a determination module, for determining a status of an touch event according to the plurality of detection results.

10. The touch detection device of claim 9, wherein the determination module determines that the touch event occurs on a first sense sequence or a second sequence adjacent to the first sense sequence when the plurality of detection results indicate that a voltage difference between the first sense sequence and the second sense sequence, when receiving pulse signals, is greater than a predetermined value.

11. The touch detection device of claim 9, wherein the determination module determines that the touch event does not occur when the plurality of detection results indicate that a voltage difference between the first sense sequence and the second sense sequence, when receiving the pulse signals, is smaller than a predetermined value.

12. The touch detection device of claim 9, wherein the determination module determines that an erroneous decision occurs when the plurality of detection results indicate that an amount of voltage differences, between adjacent sense sequences of the plurality of sense sequences and greater than a predetermined value, is greater than a predetermined number.

13. The touch detection device of claim 9, wherein the voltage difference detection module comprises a plurality of detecting units, and each of the detecting units is coupled to two adjacent sense sequences of the plurality of sense sequences, for detecting voltage differences of the two adjacent sense sequences when receiving pulse signals.

14. The touch detection device of claim 13, wherein each of the detecting unit is a differential amplifier.

15. The touch detection device of claim 9, wherein the voltage difference detection module comprises:
a detecting unit, comprising a first input terminal and a second input terminal, for detecting a voltage difference between the first input and the second input; and
a switching unit, comprising an input interface, coupled to the plurality of sense sequences, and an output interface, coupled to the first input terminal and the second input terminal of the detecting unit, for sequentially choosing two adjacent sense sequences from the plurality of sense sequences to be coupled to the output interface according to a pulse signal.

16. The touch detection device of claim 15, wherein the detecting unit is a differential amplifier.

17. The touch detection device of claim 15, wherein the signal output module outputs the plurality of pulse signals to the plurality of sense sequences sequentially.

18. The touch detection device of claim 9, wherein the touch pad is a liquid crystal display panel, and the plurality of sense sequence are scan lines and data lines of the liquid crystal display panel.

19. A touch display device having display and touch functions, comprising:
a liquid crystal display panel, comprising a plurality of pixel units and a plurality of wires arranged as a matrix, each pixel unit formed at an intersection of two orthogonal wires;
an image driving module, for outputting a plurality of control signals and a plurality of image data signals to the plurality of wires according to an image data, to drive the plurality of pixel units to display images; and
a touch detection device, coupled to the plurality of wires, for determining a status of an touch event according to capacitance variation of the plurality of wires.

20. The touch display device of claim 19, wherein the touch detection device comprises:
a signal output module, for outputting a plurality of pulse signals to the plurality of wires;
a voltage-difference detection module, for detecting voltage differences between adjacent wires of the plurality of wires when receiving the plurality of pulse signals, to generate a plurality of detection results; and
a determination module, for determining a status of an touch event according to the plurality of detection results.

21. The touch display device of claim 20, wherein the determination module determines that the touch event occurs on a first wire or a second sequence adjacent to the first wire when the plurality of detection results indicate that a voltage difference between the first wire and the second wire, when receiving pulse signals, is greater than a predetermined value.

22. The touch display device of claim 20, wherein the determination module determines that the touch event does not occur when the plurality of detection results indicate that a voltage difference between the first wire and the second wire, when receiving the pulse signals, is smaller than a predetermined value.

23. The touch display device of claim 20, wherein the signal output module is integrated in the image driving module.

24. The touch display device of claim 20, wherein the determination module determines that an erroneous decision occurs when the plurality of detection results indicate that an amount of voltage differences, between adjacent wires of the plurality of wires and greater than a predetermined value, is greater than a predetermined number.

25. The touch display device of claim 20, wherein the voltage difference detection module comprises a plurality of detecting units, and each of the detecting units is coupled to two adjacent wires of the plurality of wires, for detecting the voltage differences of the two adjacent wires, when receiving pulse signals.

26. The touch display device of claim 25, wherein each of the detecting units is a differential amplifier.

27. The touch display device of claim 20, wherein the voltage difference detection module comprises:
a detecting unit, comprising a first input terminal and a second input terminal, for detecting a voltage difference between the first input and the second input; and
a switching unit, comprising an input interface, coupled to the plurality of wires, and an output interface, coupled to the first input terminal and the second input terminal of the detecting unit, for sequentially choosing two adjacent wires from the plurality of wires to be coupled to the output interface according to a pulse signal.

28. The touch display device of claim 27, wherein the detecting unit is a differential amplifier.

29. The touch display device of claim 20, wherein the signal output module outputs the plurality of pulse signals to the plurality of wires sequentially.
